(19) United States
(12) Patent Application Publication
(10) Pub. No.: US 2002/0096847 A1
(43) Pub. Date: Jul. 25, 2002

(54) Folding structure of scooter

(76) Inventor: Anthony Shaw, Taichung (TW)

Correspondence Address: BROWDY AND NEIMARK, P.L.L.C., 624 NINTH STREET, NW, SUITE 300, WASHINGTON, DC, 20001-5303, US

(21) Appl. No.: 09/767,907

(22) Filed: Jan. 24, 2001

(51) Int. Cl. B62M 1/00; B62K 15/00

(52) U.S. Cl. 280/87.041; 280/655.1; 280/87.05

(57) ABSTRACT

A scooter folding structure comprises a fastening seat, a connection seat, a retaining member, an urging member, and an actuation member. The fastening seat is fastened with the footboard of the scooter. The connection seat is fastened with the handlebar frame of the scooter such that the connection seat is pivoted with the fastening seat to swivel between a first position and a second position. When the connection seat is located at the first position, the retaining member is urged by the urging member to remain at a fixed position at which the fastening seat and the connection seat are securely joined together. The retaining member can be actuated by the actuation member to withdraw, thereby enabling the connection seat to swivel to locate at the second position at which the scooter is folded.

### FIELD OF THE INVENTION

The present invention relates generally to a scooter, and more particularly to a folding structure of the scooter.

### BACKGROUND OF THE INVENTION

As shown in FIG. 1, a scooter folding mechanism of the prior art comprises a connection seat 1 and a fastening frame 3 pivoted to the connection seat 1 by a pivot 2. The connection seat 1 is fastened securely with the scooter footboard. The connection seat 1 is provided in two side walls with two slots 1a. The fastening frame 3 is provided with a groove 3a in which a pin 4 is disposed such that the pin 4 is fastened at one end with a wrenching member 5, and that the pin 4 is fastened at other end with a bolt. As the bolt is unfastened, the pin 4 is moved upward by the wrenching member 5 to separate from the slot 1a, thereby enabling the fastening frame 3 to be folded or unfolded. As the pin 4 is inserted into another slot 1a, the bolt is fastened. In the meantime, the wrenching member 5 is pressed to fix each component. The folding process and the unfolding press of the fastening frame 3 are time-consuming and devoid of safety features.

### SUMMARY OF THE INVENTION

The primary objective of the present invention is to provide a scooter folding structure which is easy and safe to use.

The scooter folding structure of the present invention comprises a fastening seat, a connection seat, a retaining member, an urging member, and an actuation member. The fastening seat is disposed on the scooter footboard and is provided with a receiving slot. The connection seat is pivoted with the fastening seat such that the connection seat swivels between a first position and a second position. The connection seat is provided with an insertion slot corresponding in location to the receiving slot at the time when the connection seat is located at the first position. The connection seat is fastened with the scooter handlebar frame. The retaining member is disposed in the receiving slot such that the retaining member is acted on by the urging member to move between the receiving slot and the insertion slot, thereby enabling the connection seat to remain at the first position. As the actuation member is exerted on by an external force, the retaining member is actuated by the actuation member to move into the receiving slot, thereby enabling the connection seat to be moved to the second position.

### BRIEF DESCRIPTION OF THE DRAWINGS

FIG. 1 shows a scooter folding mechanism of the prior art.

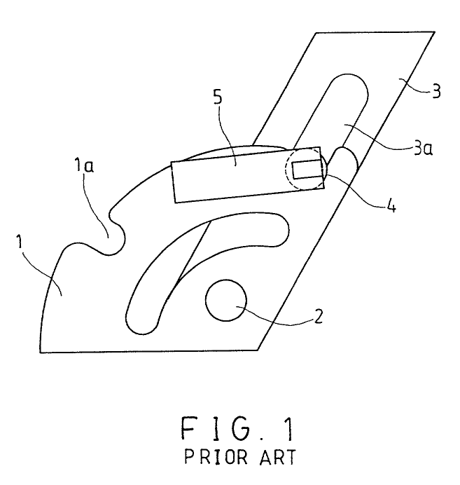

FIG. 2 shows a perspective view of a preferred embodiment of the present invention.

FIG. 3 shows a schematic view of the preferred embodiment of the present invention at work.

FIG. 4 shows a front schematic view of the preferred embodiment of the present invention.

FIG. 5 shows a sectional view taken along the direction indicated by a line 5-5 as shown in FIG. 4.

FIG. 6 shows a sectional view of the preferred embodiment of the present invention in the folding state.

FIG. 7 shows a sectional view of the preferred embodiment of the present invention in the unfolding state.

### DETAILED DESCRIPTION OF THE INVENTION

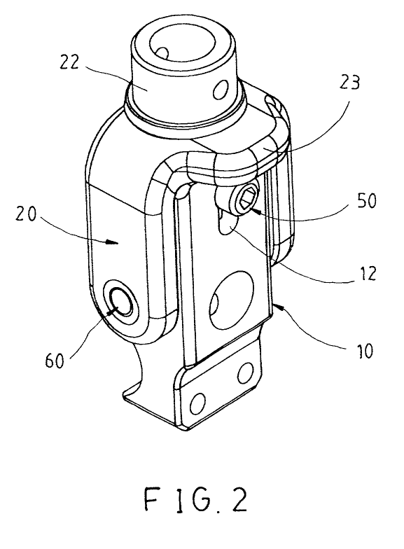

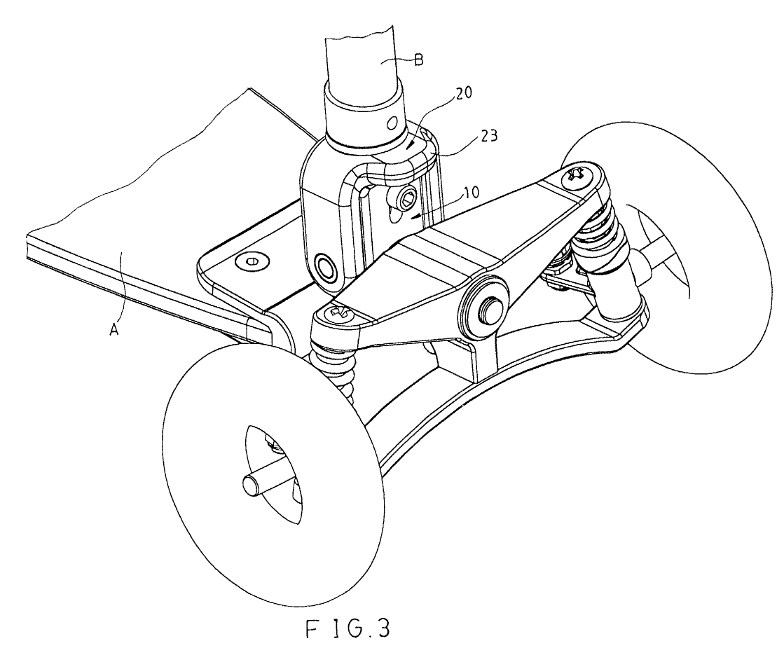

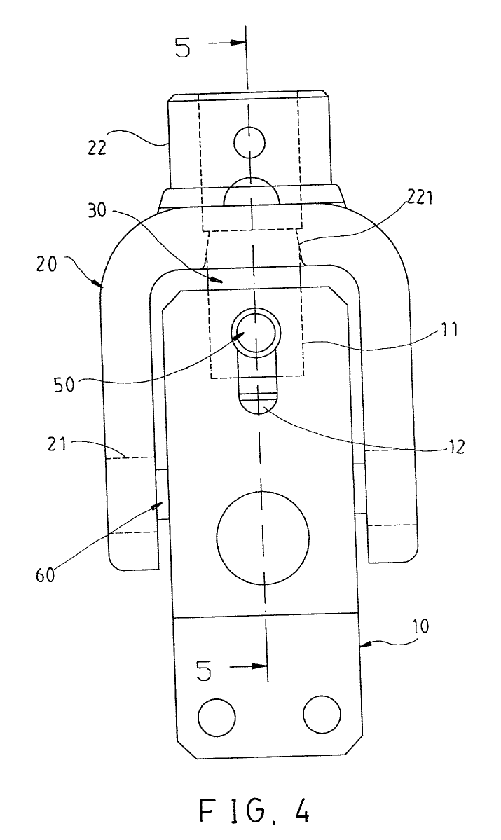

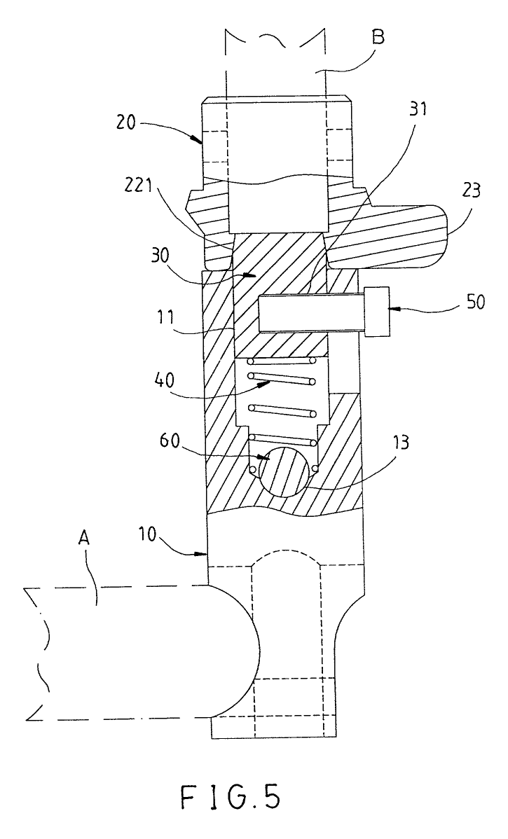

As shown in FIGS. 2-5, a scooter folding structure embodied in the present invention is fastened between a scooter footboard A and a handlebar frame B of the scooter, so as to fold the handlebar frame B toward or away from the scooter footboard A.

The scooter folding structure of the present invention comprises a fastening seat 10, a connection seat 20, a retaining member 30, an urging member 40, and an actuation member 50.

The fastening seat 10 is of a columnar construction and is fastened with the front end of the scooter footboard A. The fastening seat 10 is provided at the top with a receiving slot 11, and at the front side with a longitudinally-oriented slot hole 12 in communication with the receiving slot 11. The fastening seat 10 is further provided with a horizontally-oriented shaft hole 13.

The connection seat 20 is of an inverted U-shaped construction and is provided in two side wing plates with a connection hole 21 in which a pivot 60 is received such that the pivot 60 is put through the shaft hole 13, so as to pivot the connection seat 20 with the fastening seat 10 such that the connection seat 20 swivels between a vertically-oriented first position and a horizontally-oriented second position. The connection seat 20 is provided in the top with a hollow neck portion 22 extending upwards therefrom. The neck portion 22 is fastened at the top section thereof with the handlebar frame B and is provided in the bottom section thereof with an insertion hole 221 equal in diameter to the receiving slot 11 and corresponding in location to the receiving slot 11 at the time when the connection seat 20 is located at the first position. The connection seat 20 is provided in the front side of the top plate thereof with a protruded edge 23.

The retaining member 30 is of a cylindrical construction and is disposed in the receiving slot 11. When the connection seat 20 is located at the first position, the top section of the retaining member 30 is received in the insertion slot 221. In the meantime, the bottom section of the retaining member 30 is received in the receiving slot 11. The retaining member 30 has a threaded hole 31 which is provided in the top edge with a guide angle.

The urging member 40 is a spring, which is disposed in the receiving slot 11 such that the spring 40 is located under the retaining member 30 for providing the retaining member 30 with an upward action force enabling the retaining member 30 to remain between the receiving slot 11 and the insertion slot 221 at such time when the connection seat 20 is located at the first position. As a result, the handlebar frame B is kept in an upright position.

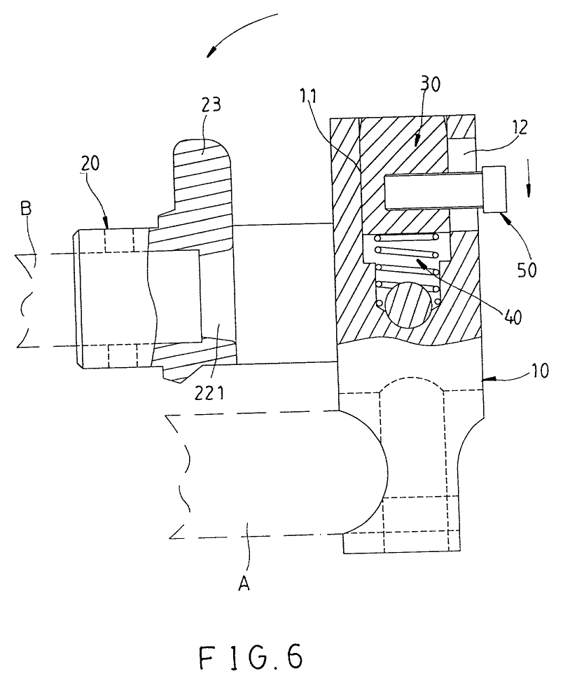

The actuation member 50 is a bolt, which is engaged with the threaded hole 31 of the retaining member 30 via the slot hole 12, with the head of the bolt 50 being jutted out of the fastening seat 10. When the head of the bolt 50 is forced downward, the bolt 50 is displaced downward along the slot hole 12, thereby linking the retaining member 30 to move into the receiving slot 11 in which the spring 40 is compressed by the retaining member 30. In the meantime, the top section of the retaining member 30 is no longer kept in the insertion slot 221. As a result, the connection seat 20 can be swiveled to the second position, as shown in FIG. 6. The scooter is thus folded.

In light of the retaining member 30 being forced by the urging member 40 to locate securely between the fastening seat 10 and the connection seat 20, the handlebar frame B of the scooter is securely kept in the upright position to prevent accident. The handlebar frame B can be easily folded against the footboard A by forcing downward the actuation member 50.

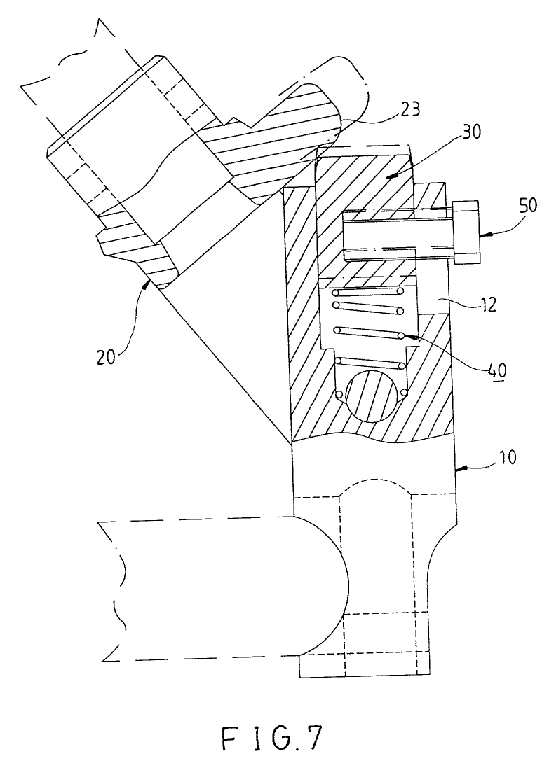

As shown in FIG. 7, the folded scooter can be easily unfolded by raising the folded handlebar frame B to link the connection seat 20 such that the protruded edge 23 of the front end of the connection seat 20 presses the urging member 40 to displace downward until such time when the connection seat 20 and the fastening seat 10 are once again joined together.

What is claimed is:

1. A folding structure of a scooter, said folding structure connecting a footboard and a handlebar frame of the scooter and comprising:
a fastening seat fastened with the footboard and provided with a receiving slot;
a connection seat pivoted with said fastening seat such that said connection seat swivels between a first position and a second position, said connection seat being provided with an insertion slot corresponding in location to said receiving slot of said fastening seat at such time when said connection seat is located at said first position, said connection seat being fastened with the handlebar frame;
a retaining member disposed in said receiving slot;
an urging member for providing said retaining member with an action force enabling said retaining member to remain between said receiving slot and said insertion slot, so as to keep said connection seat at said first position; and
an actuation member for actuating said retaining member to move to said receiving slot, thereby enabling said connection seat to be swiveled to locate at said second position.

2. The folding structure as defined in claim 1, wherein said fastening seat is provided with a slot hole in communication with said receiving slot; wherein said actuation member is disposed in said slot hole such that said actuation member is fastened at one end with said retaining member, and that other end of said actuation member is jutted out of said fastening seat.

3. The folding structure as defined in claim 1, wherein said urging member is a spring.

4. The folding structure as defined in claim 1, wherein said connection seat is provided with a protruded edge whereby said protruded edge presses against said retaining member to move into said receiving slot of said fastening seat at such time when said connection seat is swiveled to locate at said first position from said second position.
